(19) United States
(12) Patent Application Publication
(10) Pub. No.: US 2025/0355603 A1
(43) Pub. Date: Nov. 20, 2025

(54) IMAGE PROCESSING APPARATUS THAT ESTIMATES USE ENVIRONMENT, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: TAKUMI MAEDA, Kanagawa (JP)

(21) Appl. No.: 19/205,471

(22) Filed: May 12, 2025

(30) Foreign Application Priority Data
May 15, 2024 (JP) 2024-079259

(51) Int. Cl. G06F 3/12; G06F 3/0482; G06F 3/0485

(52) U.S. Cl. CPC G06F 3/1239; G06F 3/0482; G06F 3/0485

(57) ABSTRACT

An image processing apparatus includes a display panel and a controller. The controller controls displaying, on the display panel, an operation screen including an operation portion for instructing execution of estimation of a use environment of the image processing apparatus and estimation execution information located together with the operation portion that indicates that the estimation is executed when the operation portion is operated. During execution of the estimation, the controller changes the estimation execution information displayed on the display panel to under estimation information indicating that the estimation is being executed.

### BACKGROUND

### Field

The present disclosure relates to image processing apparatuses, methods for controlling image processing apparatuses, and storage media.

### Description of the Related Art

Some image processing apparatuses (image forming apparatuses) having printing functions and scanning functions are configured to enable users to select, on a setting screen, setting of a use environment (utilization environment) in which the image processing apparatuses are used. When a user selects desired setting of the use environment on the setting screen of an image processing apparatus, the image processing apparatus becomes usable under the selected setting. Some image processing apparatuses can estimate setting of their use environment and notifying the estimated setting of the use environment. For example, Japanese Laid-Open Patent Publication No. 2023-084818 discloses an information processing apparatus configured to receive an instruction to estimate its use environment. In this information processing apparatus, a display device such as a touch panel displays an item to be operated (selected) by a user who provides an instruction to estimate the use environment.

In such an information processing apparatus, estimating its use environment can take some time. Therefore, it is preferable for users to understand whether an apparatus in use is in the process of estimating its use environment. For example, in a case where a user does not understand that the apparatus is in the process of estimating its use environment, the user may provide a new estimation instruction even though the apparatus is still in the process of estimating its use environment. The user may select a use environment based on a previous estimation result even though the apparatus is still in the estimation process and has not yet presented a result of the current estimation. The size of a display panel that displays a setting screen may make it difficult to display an additional item on the display panel to indicate that the estimation is in process.

### SUMMARY

The present disclosure provides an image processing apparatus, a method for controlling an image processing apparatus, and a storage medium that enable users to easily understand, when the image processing apparatus is estimating a use environment in which the image processing apparatus is used, that the estimation process is in progress with a simple configuration.

According to an aspect of the disclosure, an image processing apparatus includes a display panel that displays a screen enabling a user to perform a scrolling operation and a controller that performs control to display, on the display panel, an operation screen including an operation portion that receives an operation to instruct execution of estimation of a use environment in which the image processing apparatus is used and estimation execution information located together with the operation portion that indicates that the estimation is executed when the operation portion is operated, and changes, while the estimation is being executed, the estimation execution information displayed on the display panel to under estimation information indicating that the estimation is being executed.

Further features of the present disclosure will become apparent from the following description of exemplary embodiments with reference to the attached drawings.

### BRIEF DESCRIPTION OF THE DRAWINGS

FIG. 1 is a diagram illustrating an example of a use environment in which an image processing apparatus according to a first embodiment is used.

FIG. 2 is a flowchart illustrating an example of processing of classifying a use environment of the image processing apparatus.

FIG. 3 is a block diagram illustrating an example of a hardware configuration of an image forming apparatus.

FIG. 4 is a block diagram illustrating an example of a software configuration of the image forming apparatus.

FIG. 5A is a diagram illustrating an example of a screen displayed on a liquid crystal display of the image forming apparatus.

FIG. 5B is a diagram illustrating an example of the screen displayed on the liquid crystal display of the image forming apparatus.

FIG. 6 is a diagram illustrating an example of the screen displayed on the liquid crystal display of the image forming apparatus.

FIG. 7 is a diagram illustrating an example of the screen displayed on the liquid crystal display of the image forming apparatus.

FIG. 8 is a diagram illustrating an example of the screen displayed on the liquid crystal display of the image forming apparatus.

FIG. 9 is a flowchart illustrating processes executed by the image forming apparatus.

FIG. 10 is a flowchart illustrating processes executed by an image forming apparatus according to a second embodiment.

FIG. 11 is a flowchart illustrating processes executed by an image forming apparatus according to a third embodiment.

### DESCRIPTION OF THE EMBODIMENTS

The present disclosure will be described in detail below with reference to the accompanying drawings illustrating embodiments thereof.

The configurations described in the following embodiments are merely examples, and the scope of the present disclosure is not limited by configurations described in the embodiments. For example, each unit or component constituting the present disclosure can be replaced with one having any configuration that exhibits similar functions. Any component may be added the configurations described in the embodiments. Any two or more configurations (features) in the embodiments may be combined.

### First Embodiment

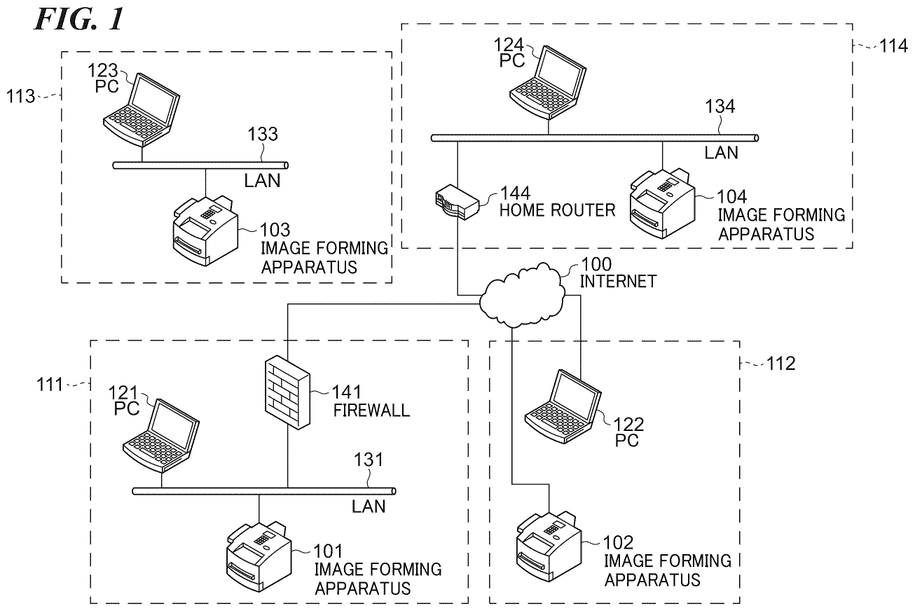

Hereinafter, a first embodiment will be described with reference to FIGS. 1 to 9.

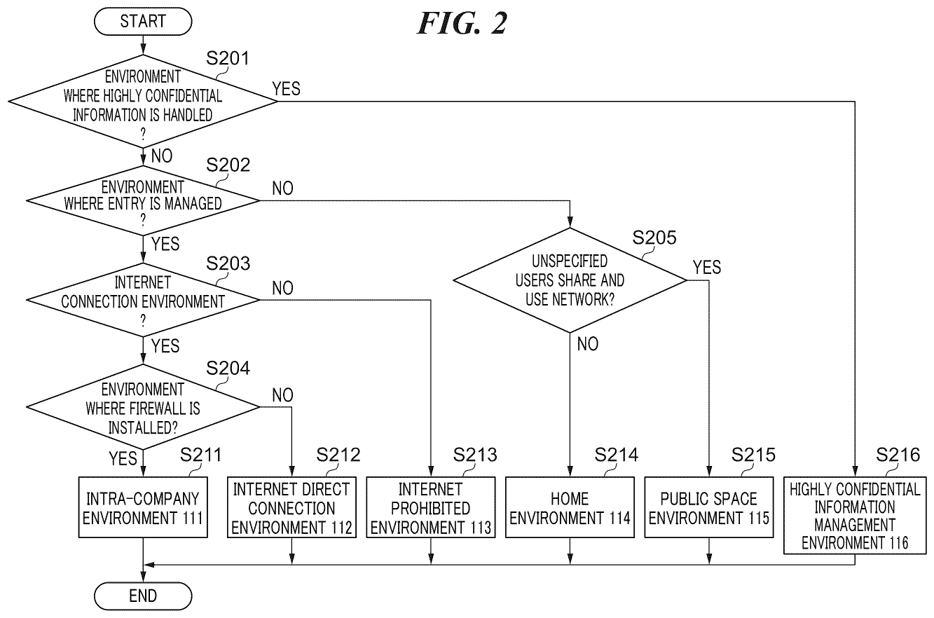

FIG. 1 is a diagram illustrating an example of a use environment in which an image forming apparatus is used according to the first embodiment. As illustrated in FIG. 1, image forming apparatuses (image processing apparatuses) 101 to 104 are used in use environments (installation environments) different from each other. Specifically, the image forming apparatus 101 is used in an intra-company environment 111. The image forming apparatus 102 is used in an Internet direct connection environment 112. The image forming apparatus 103 is used in an Internet prohibited environment 113. The image forming apparatus 104 is used in a home environment 114. The use environments also include a public space environment 115 and a highly confidential information management environment 116 (see FIG. 2).

The intra-company environment 111 includes the image forming apparatus 101, a PC 121, and a firewall 141. The image forming apparatus 101 and the PC 121 are connected via, for example, a LAN (Local Area Network) 131 in a company. The firewall 141 is installed between the LAN 131 and the Internet 100. The firewall 141 monitors and protects communication between the image forming apparatus 101 and the PC 121. As a result, in the intra-company environment 111, it is possible to greatly reduce a threat such as access to the image forming apparatus 101 or to the PC 121 by a third party (attacker) via the Internet 100.

The Internet direct connection environment 112 includes the image forming apparatus 102 and a PC 122. The image forming apparatus 102 and the PC 122 are both directly connected to the Internet 100. Therefore, in the Internet direct connection environment 112, it is preferable that the image forming apparatus 102 and the PC 122 take countermeasures against a threat such as access by a third party via the Internet 100. As a countermeasure, for example, a personal firewall function or the like built in each of the image forming apparatus 102 and the PC 122 can be used.

The Internet prohibited environment 113 includes the image forming apparatus 103 and a PC 123. The image forming apparatus 103 and the PC 123 are connected to each other via a LAN 133. As a result, in the Internet prohibited environment 113, the image forming apparatus 103 and the PC 123 are used in a closed network environment isolated from the Internet 100. This prevents the image forming apparatus 103 and the PC 123 from being accessed by unspecified users on the Internet 100.

The home environment 114 includes the image forming apparatus 104, a PC 124, and a home router 144. The image forming apparatus 104 and the PC 124 are connected to each other via a LAN 134 in a home. The LAN 134 is connected to the Internet 100 via a private network configured by the home router 144. In the home environment 114, for example, there is no security countermeasure by the firewall 141 as in the intra-company environment 111. Therefore, in the home environment 114, similarly to the Internet direct connection environment 112, it is preferable that the image forming apparatus 104 and the PC 124 take countermeasures against a threat such as access by a third party via the Internet 100. As a countermeasure, for example, a personal firewall function or the like built in each of the image forming apparatus 104, the PC 124, and the home router 144 can be used.

FIG. 2 is a flowchart illustrating an example of processing of classifying a use environment of the image forming apparatus. As illustrated in FIG. 2, in step S201, it is determined whether the image forming apparatus is in an environment in which the image forming apparatus handles highly confidential information, i.e., an environment in which it is necessary to give top priority to security countermeasures. In a case where it is determined that the image forming apparatus is in the environment in which the image forming apparatus handles highly confidential information, the processing proceeds to step S216. In a case where it is determined that the image forming apparatus is not in the environment in which the image forming apparatus handles highly confidential information, the processing proceeds to step S202.

In step S202, it is determined whether a room in which the image forming apparatus is installed is in an environment in which room entry is managed. This determination is made, for example, based on whether unspecified users can physically access the image forming apparatus in the room, i.e., whether users entering the room in which the image forming apparatus is installed are restricted. Examples of a method for restricting entry of users into the room include, but are not limited to, a method of using access cards or a method for locking a room during non-working hours under the condition that only people belonging to an organization are working in the room during working hours, so the number of people who can actually enter the room is limited.

In a case where, in step S202, it is determined that the room in which the image forming apparatus is installed is in the environment in which room entry is managed, the processing proceeds to step S205. In a case where it is determined that the room in which the image forming apparatus is installed is not in the environment in which room entry is managed, the processing proceeds to step S203.

In step S203, it is determined whether the image forming apparatus is connected to an external network such as the Internet. In a case where it is determined that the image forming apparatus is connected to the external network such as the Internet, the processing proceeds to step S204. In a case where it is determined that the image forming apparatus is not connected to the external network such as the Internet, the processing proceeds to step S213.

In step S204, it is determined whether a firewall is installed. In a case where it is determined that the firewall is installed, the processing proceeds to step S211. In a case where it is determined that the firewall is not installed, the processing proceeds to step S212.

In step S205, it is determined whether unspecified users share and use a network in the environment. In a case where it is determined that unspecified user share and use the network in the environment, the processing proceeds to step S215. In a case where it is determined that unspecified users do not share and use the network in the environment, the processing proceeds to step S214.

In step S211, the use environment of the image forming apparatus is classified as the intra-company environment 111. The intra-company environment 111 is a private network environment that can be monitored and protected by the firewall 141.

In step S212, the use environment of the image forming apparatus is classified as the Internet direct connection environment 112.

In step S213, the use environment of the image forming apparatus is classified as the Internet prohibited environment 113. The Internet prohibited environment 113 is a private network environment in which room entry is managed and a closed network is allowed to be used.

In step S214, the use environment of the image forming apparatus is classified as the home environment 114. The home environment 114 is a private network environment in which a user can be specified.

In step S215, the use environment of the image forming apparatus is classified as the public space environment 115.

In step S216, the use environment of the image forming apparatus is classified as the highly confidential information management environment 116.

Next, with reference to Table 1 below, a description is provided of security countermeasures to be taken in each of the use environments (the intra-company environment 111, the Internet direct connection environment 112, the Internet prohibited environment 113, the home environment 114, the public space environment 115, and the highly confidential information management environment 116). In each of the image forming apparatuses 101 to 104, setting items related to security functions and other setting items are set, and various controls are executed according to setting values corresponding to the setting items. Table 1 illustrates setting items related to the security functions to be used for each use environment.

TABLE 1

| | Use Environment | | | | | |
|---|---|---|---|---|---|---|
| | | | | | | Highly |
| | | Internet | | | | Confidential |
| | Intra- | Direct | Internet | | Public | Information |
| | company | Connection | Prohibited | Home | Space | Management |
| | Environment | Environment | Environment | Environment | Environment | Environment |
| Setting Item | 111 | 112 | 113 | 114 | 115 | 116 |
| Encryption of | ON | ON | | ON | ON | ON |
| Communication Path | | | | | | |
| Invalidating Legacy | ON | ON | | ON | ON | ON |
| Protocol | | | | | | |
| Validating Personal | | ON | | ON | ON | ON |
| Firewall | | | | | | |
| Security Enhancement for | ON | ON | | ON | ON | ON |
| Authentication | | | | | | |
| Physical Attack | | | | ON | ON | ON |
| Countermeasure | | | | | | |
| Invalidating File Sharing | | ON | | | ON | ON |
| Function | | | | | | |
| Invalidating External | ON | ON | ON | ON | ON | ON |
| Storage Device | | | | | | |

A first setting item “Encryption of Communication Path” indicates a security countermeasure for preventing information leakage by encrypting communication contents on a network. Examples of a function of implementing encryption of a communication path include TLS (Transport Layer Security). In environments connected to the Internet, there is a possibility of eavesdropping of communication contents by a third party, and thus it is preferable to encrypt a communication path. Therefore, the setting item of the “Encryption of Communication Path” is preferably set to ON in each of the use environments except for the Internet prohibited environment 113.

A second setting item “Invalidating Legacy Protocol” indicates a security countermeasure for preventing, for example, impersonation and information leakage by invalidating a function using an unsafe legacy communication protocol. Examples of the legacy protocol include WINS (Windows Internet Name Service). Similarly to the “Encryption of Communication Path”, it is preferable to invalidate a legacy protocol in a use environment connected to the external network such as the Internet. Therefore, setting items of the “Invalidating Legacy Protocol” are preferably set to ON in the use environments except for the Internet prohibited environment 113.

A third setting item “Validating Personal Firewall” is a setting item for validating a firewall that can be installed and used in the image forming apparatus. The personal firewall monitors communication between the image forming apparatus and the external network such as the Internet, similarly to an ordinary firewall. Examples of the personal firewall include an IP filter and a port number filter. The IP filter is a security countermeasure of reading transmission destination information and transmission source information of a communication packet and permitting only a communication packet set in advance. As a result, unauthorized access and information leakage can be prevented. The port number filter is a security countermeasure of closing a port not to be used to prevent entry from the port in the closed state. This enables preventing DOS (Denial of Service), which is a cyberattack that applies a large amount of load and causes vulnerability. In environments connected to the external network and in which no firewall is installed, there is a possibility of information leakage or DoS, and thus it is preferable to validate the personal firewall. Therefore, the setting item of the “Validating Personal Firewall” is preferably set to ON in each of the use environments except for the intra-company environment 111 and the Internet prohibited environment 113.

A fourth setting item “Security Enhancement for Authentication” is a setting item for enhancing countermeasures against impersonation by, for example, prohibiting password caching or specifying the minimum number of characters of a password. Since there is a possibility of impersonation in environments except for a use environment connected in an isolated network, it is preferable to enhance security of authentication. Therefore, the setting item of the “Security Enhancement for Authentication” is preferably set to ON in each of the use environments except for the Internet prohibited environment 113.

A fifth setting item “Physical Attack Countermeasure” indicates a security countermeasure for preventing information from being physically leaked. In the image forming apparatuses 101 to 104, temporary data such as a print job is generated and stored in the HDD 314. Each of the image forming apparatuses 101 to 104 has a complete erase function of automatically completely erasing the temporary data at the same time as the end of the job. Examples of the “Physical Attack Countermeasure” include this complete erase function. The complete erase function prevents the temporary data from being read from the HDD 314 even when the HDD 314 is physically removed from each of the image forming apparatuses 101 to 104. It is preferable to implement “Physical Attack Countermeasures” in a use environment in which room entry is not managed so that physical access to the image forming apparatus cannot be restricted, or in a use environment in which the highest priority is given to reduction of a risk of information leakage. Therefore, the setting item of the Physical Attack Countermeasure” is preferably set to ON in each of the home environment 114, the public space environment 115, and the highly confidential information management environment 116.

A sixth setting item “Invalidating File Sharing Function” is a setting item for invalidating a function of sharing a file on the network in the environment. Examples of setting related to the file sharing function include SMB (Server Message Block) server setting. In environments in which unspecified users share a network in the environment, it is preferable to invalidate the file sharing function in order to prevent information leakage. In other words, it is recommended to invalidate the file sharing function in environments except for a private network environment in which specific users share the network in the environment. As described above, the intra-company environment 111, the Internet prohibited environment 113, and the home environment 114 are private network environments. Therefore, the setting item of the “Invalidating File Sharing Function” is preferably set to ON in each of the Internet direct connection environment 112, the public space environment 115, and the highly confidential information management environment 116 other than the above environments.

A seventh setting item “Invalidating External Storage Device” is a setting item for setting, for example, a USB (Universal Serial Base) storage device to be unusable as an external storage device for the image forming apparatus. This prevents information from being written into the external storage device, and as a result, information leakage can be prevented. In addition, it is possible to prevent infection with a computer virus via the USB storage device and information leakage associated with the infection. A threat of information leakage by the external storage device is common in any use environment. Therefore, setting item of the “Invalidating External Storage Device” preferably set to ON in all the use environments.

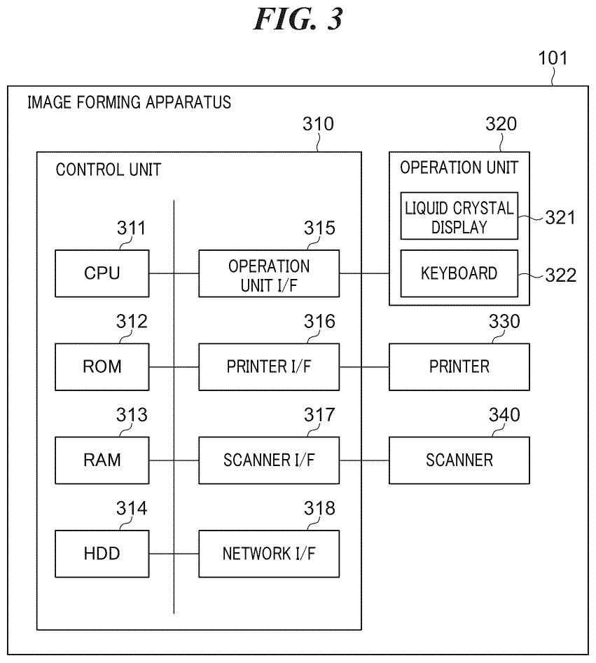

FIG. 3 is a block diagram illustrating an example of a hardware configuration of the image forming apparatus 101. Since the image forming apparatuses 101 to 104 have the same hardware configuration, the hardware configuration of the image forming apparatus 101 will be representatively described. The image forming apparatus 101 illustrated in FIG. 3 is an apparatus that performs image processing. The image forming apparatus 101 is not particularly limited, and for example, an apparatus such as an MFP (Multi-Function Peripheral), an SFP (Single Function Printer), or a function scanner can be used. As the image forming apparatus 101, for example, an apparatus such as a 3D printer or a 3D scanner can also be used.

The image forming apparatus 101 includes a control unit 310, an operation unit 320, a printer 330, and a scanner 340. The control unit 310 includes a CPU (Central Processing Unit) 311, a ROM (Read Only Memory) 312, and a RAM (Random Access Memory) 313. In addition, the control unit 310 includes an HDD (Hard Disk Drive) 314, an operation unit I/F (Interface) 315, a printer I/F 316, a scanner I/F 317, and a network I/F 318.

The control unit 310 is a computer that controls the entire operation of the image forming apparatus 101. The ROM 312 stores control programs to be executed by the CPU 311. The CPU 311 reads the control programs stored in the ROM 312, and performs various controls of the image forming apparatus 101 such as reading control and transmission control. The control programs include, for example, a program for causing a computer to execute operations of units or components of the image forming apparatus 101 and processing (steps of a method for controlling the image processing apparatus) of the image forming apparatus 101. The RAM 313 is used as a main memory of the CPU 311 or a temporary storage area such as a work area. The HDD 314 stores, for example, image data, various programs, and various setting information. The control unit 310 may include another storage device in addition to the HDD 314, such as an SSD (Solid State Drive).

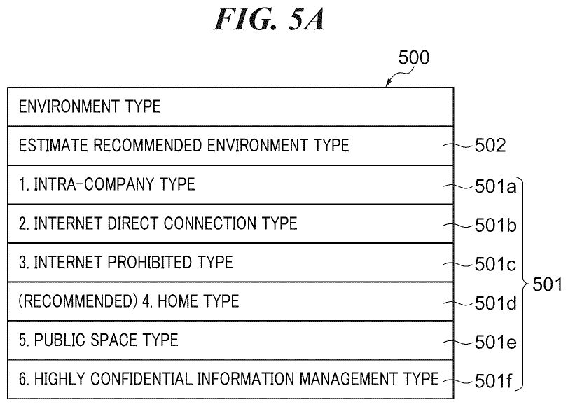

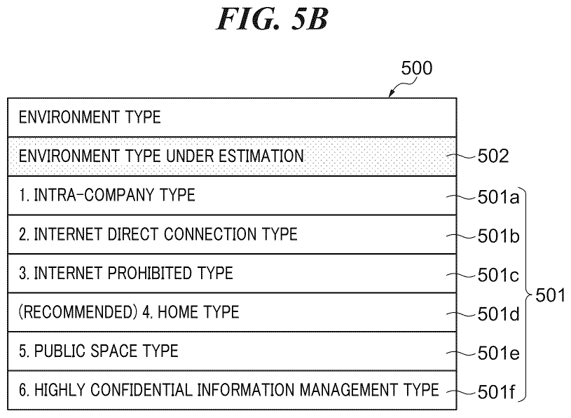

The control unit 310 is connected to the operation unit 320 via the operation unit I/F 315. The operation unit 320 includes, for example, a liquid crystal display (display panel) 321 having a touch panel function, a keyboard 322, and the like. As a result, the operation unit 320 functions as a display unit that presents information to a user and also as an acceptance unit (input device) that accepts an instruction provided by a user. The liquid crystal display 321 is configured to enable a user to scroll a screen. A size of the liquid crystal display 321 in this case is, for example, approximately three inches. For example, in an environment type list screen 500 in FIGS. 5A and 5B, lines up to a fifth line (button 501c) are set as a default display area. When a user performs a scroll operation on the screen, the liquid crystal display 321 displays the remaining area.

The control unit 310 is connected to the printer 330 via the printer I/F 316. Image data to be printed by the printer 330 is transmitted from the control unit 310 to the printer 330 via the printer I/F 316. The printer 330 receives the image data from the control unit 310 and prints the image data on a medium such as printing paper.

The control unit 310 is connected to the scanner 340 via the scanner I/F 317. The scanner 340 reads a document placed on a platen (not illustrated) of the image forming apparatus 101 and generates image data of the document. This image data is transmitted to the control unit 310 via the scanner I/F 317. A network cable is connected to the network I/F 318. This enables the image forming apparatus 101 to communicate with an external apparatus such as the PC 121 on the LAN 131. The communication between the image forming apparatus 101 and the external apparatus is wired communication, but it is not limited thereto, and may be, for example, wireless communication. For the image forming apparatus 102, the Internet 100 is connected to the network I/F 318 of the image forming apparatus 102. In a case of the image forming apparatus 103, the LAN 133 is connected to the network I/F 318 of the image forming apparatus 103. For the image forming apparatus 104, the LAN 134 is connected to the network I/F 318 of the image forming apparatus 104.

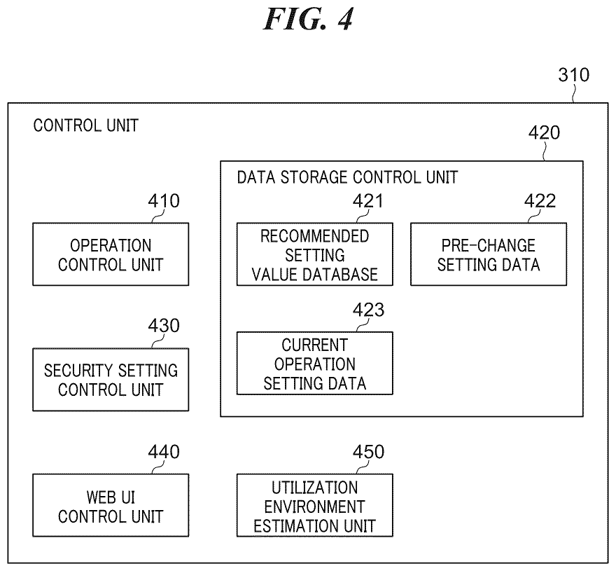

FIG. 4 is a block diagram illustrating an example of a software configuration of the image forming apparatus. As illustrated in FIG. 4, the control unit 310 includes an operation control unit 410, a data storage control unit 420, a security setting control unit 430, a web UI (User Interface) control unit 440, and a utilization environment estimation unit (use environment estimation unit) 450 as software. These units are implemented by the CPU 311 executing a corresponding program stored in the ROM 312.

The operation control unit 410 is configured to display a screen on the operation unit 320 (the liquid crystal display 321). The operation control unit 410 is also configured to detect a user operation on the operation unit 320, and then switch the screen or update a display content based on the detection result.

The data storage control unit 420 is configured to store data in the HDD 314 and read data from the HDD 314. The data storage control unit 420 is also configured to store setting information for controlling the operation of the image forming apparatus 101 and information related to the security function setting. The data storage control unit 420 includes a recommended setting value database 421, pre-change setting data 422, and current operation setting data 423.

The recommended setting value database 421 is a database including the setting items (see Table 1) related to the security functions for each use environment described above. The setting items recommended for each use environment is indicated as “ON” in Table 1. For example, it is recommended for the intra-company environment 111 to use the “Encryption of Communication Path”, the “Invalidating Legacy Protocol”, the “Security Enhancement for Authentication”, and the “Invalidating External Storage Device”. In the present embodiment, the recommended setting value database 421 is defined in advance by a vendor (manufacturer) of the image forming apparatus 101 and stored in the data storage control unit 420. The setting items crossed out in Table 1 are items that can be omitted for the use environment, and the omitted setting items are set to the pre-change setting data 422. The current operation setting data 423 includes setting items that have already been set to ON for the current use environment, i.e., the items marked “ON” in Table 1. The current operation setting data 423 may be, for example, generated by an application in an external information processing apparatus.

The security setting control unit 430 is configured to collectively set the security functions of the image forming apparatus 101 based on a detection result of the operation control unit 410. Hereinafter, the function of performing collective setting is referred to as “collective setting function”. In the present embodiment, the seven setting items in Table 1 are setting targets of the collective setting function. A user, such as an administrator, may change setting of a specific setting item based on an actual utilization situation of the image forming apparatus even in a case where the setting items have been set using the collective setting function. For example, when the “Encryption of Communication Path”, the “Invalidating Legacy Protocol”, the “Security Enhancement for Authentication”, and the “Invalidating External Storage Device” has been set to ON for the intra-company environment 111, the validating personal firewall may be additionally set to ON.

The web UI control unit 440 is configured to control a setting screen displayed on the PC 121 via the network I/F 318. Users may refer to or change the setting of the image forming apparatus 101 using the setting screen on the web browser provided by the web UI control unit 440. The web UI control unit 440 may have a function of importing and exporting the recommended setting value database 421. As a result, users may create and edit a data file related to the recommended setting value database 421 on the PC 121. In addition, users may transmit the edited recommended setting value database 421 to the image forming apparatus 101 and store the edited recommended setting value database 421 in the data storage control unit 420. The web UI control unit 440 may be omitted in the control unit 310.

The utilization environment estimation unit 450 is configured to estimate a use environment in which the image processing apparatus is used. This estimation is performed based on information such as a network packet acquired by the image forming apparatus.

FIGS. 5A to 8 are diagrams illustrating an example of a screen displayed on the liquid crystal display 321 of the image forming apparatus 101. The screens illustrated in FIGS. 5A to 8 are displayed on the liquid crystal display 321 by the operation control unit 410 (the control unit 310). As described above, in the present embodiment, the operation control unit 410 functions as a control unit (controller) that performs control to display a screen on the liquid crystal display 321. In the image forming apparatus 101, the web UI control unit 440 may acquire web pages similar to these screens from a web browser of an external information processing apparatus. In this case, users may perform various setting operations via web pages.

The environment type list screen 500 illustrated in FIG. 5A is an operation screen including a use environment list button group 501 and an estimation button 502. The use environment list button group 501 includes buttons 501a to 501f.

The button 501a is marked with character information “1. Intra-company Type”. When the button 501a is operated, the intra-company environment 111 is selected and set for the use environment of the image forming apparatus.

The button 501b is marked with character information “2. Internet Direct Connection Type”. When the button 501b is operated, the Internet direct connection environment 112 is selected and set for the use environment of the image forming apparatus.

The button 501c is marked with character information “3. Internet Prohibited Type”. When the button 501c is operated, the Internet prohibited environment 113 is selected and set for the use environment of the image forming apparatus.

The button 501d is marked with character information “4. Home Type”. When the button 501d is operated, the home environment 114 is selected and set for the use environment of the image forming apparatus. The button 501e is marked with character information “5. Public Space Type”. When the button 501e is operated, the public space environment 115 is selected and set for the use environment of the image forming apparatus.

The button 501f is marked with character information “6. Highly Confidential Information Management Type”. When the button 501f is operated, the highly confidential information management environment 116 is selected and set for the use environment of the image forming apparatus.

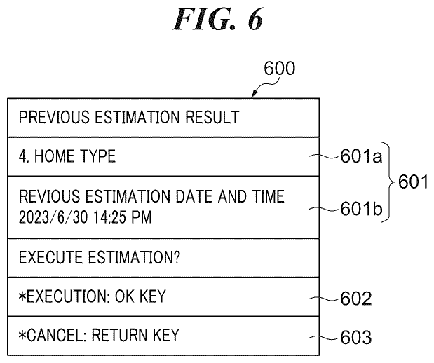

The buttons 501a to 501f serve as options from which a user selects and sets a use environment. The security setting control unit 430 is configured to read, from the recommended setting value database 421 in the data storage control unit 420, recommended setting values for a use environment corresponding to the button selected from among the buttons 501a to 501f, and then overwrite the current operation setting data 423. When the button 501d is operated from among the buttons 501a to 501f, the display of the liquid crystal display 321 changes to an estimation execution screen 600 illustrated in FIG. 6. When a previous estimation result exists, character information “Recommended” may be indicated on the screen together with the use environment that is the estimation result (see button 501d).

The estimation button 502 is an operation portion that receives an operation to instruct execution of estimation of a use environment of the image processing apparatus. The estimation button 502 is marked with character information (character string) “Estimate Recommended Environment Type” as information (estimation execution information) indicating that estimation is executed when the estimation button 502 is operated. In other words, the environment type list screen 500 (operation screen) displayed on the liquid crystal display 321 includes the estimation button 502, which is an operation portion, and the estimation execution information located together with the estimation button 502. The utilization environment estimation unit 450 estimates a use environment of the image processing apparatus in response to an operation performed on the estimation button 502. While the use environment estimation is being executed, the operation control unit 410 changes the character string “Estimate Recommended Environment Type” of the estimation execution information displayed on the liquid crystal display 321 to character information (character string) “Environment Type under Estimation” which is information (under estimation information) indicating that estimation is being executed as illustrated in FIG. 5B. That is, while the use environment estimation is being executed, the operation control unit 410 performs control to replace the estimation execution information marked on the estimation button 502 with the under estimation information and to display the replaced information on the liquid crystal display 321. This enables users to visually understand the under estimation information “Environment Type under Estimation” on the operation screen displayed on the liquid crystal display 321. Thus, the image processing apparatus is configured such that the under estimation information “Environment Type under Estimation” is displayed in the operation screen on the liquid crystal display 321 when estimating a use environment of the image processing apparatus. With such a simple configuration, users can easily understand that the estimation is in progress.

Since it can take time (e.g., about one minute) to estimate the use environment, it is preferable for users to understand that the use environment is in progress. As described above, users can easily understand that the use environment is being estimated from the operation screen displayed on the liquid crystal display 321. In a case where, for example, users fail to understand that the use environment is being estimated, the users may operate the estimation button 502 again even though the estimation is in progress. In the present embodiment, it is possible to suppress such re-operation of the estimation button 502 during the estimation of the use environment.

As illustrated in FIG. 5B, the estimation button 502 at this time is preferably colored differently from the estimation button 502 in FIG. 5A. The fact that the use environment is being estimated is emphasized by the combination of the coloring the estimation button 502 and the display of the character string “Environment Type under Estimation”, which are under estimation information. This makes it easier for users to understand that the estimation is in progress.

While the estimation of the use environment is being estimated, i.e., while the under estimation information is displayed on the liquid crystal display 321, the operation control unit 410 (operation unit 310) may restrict an operation on the estimation button 502 (the environment type list screen 500). This prevents users from operating the estimation button 502. An operation restriction method for the estimation button 502 is not limited, and examples thereof include a method of displaying the estimation button 502 on the liquid crystal display 321 in a grayed-out manner.

As illustrated in FIGS. 5A and 5B, in the environment type list screen 500, the estimation button 502 (and the character information, such as the estimation execution information and the under estimation information, located together with the estimation button 502) is arranged on an upper side of environment type list screen 500, and the use environment list button group 501 (and the character information located together with the use environment list button group 501) is arranged below the estimation button 502. The estimation button 502 located in the upper portion of the environment type list screen 500 ensures that the under estimation information “Environment Type under Estimation” is at the most visually recognizable position in the environment type list screen 500. Such arrangement is preferable when the size of the liquid crystal display 321 is relatively small (six or more inches and 12 or less inches) so that a scrolling operation is to be performed for screen display.

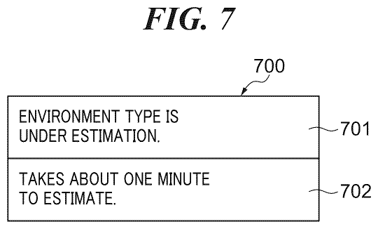

As illustrated in FIG. 6, the estimation execution screen 600 includes a previous estimation result portion 601, an estimation execution confirmation portion 602, and a return button 603. When an execution result of estimation has been already acquired, the previous estimation result portion 601 indicates a previous estimation result 601a and estimation date and time 601b as an execution result of the estimation. In FIG. 6, as an example, the previous estimation result 601a is “4. Home Type”, and the estimation date and time 601b is “2023 Jun. 30 14:25PM”. The estimation execution confirmation portion 602 is a button that receives an instruction from a user to execute the estimation. When the estimation execution confirmation portion 602 is operated, the display on the liquid crystal display 321 changes to an under estimation processing screen (under estimation screen) 700 illustrated in FIG. 7. When the return button 603 is operated, the display on the liquid crystal display 321 changes to the environment type list screen 500 illustrated in FIGS. 5A and 5B.

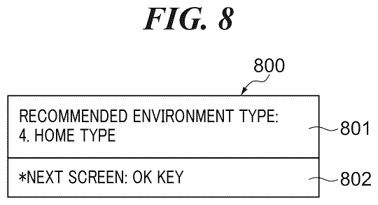

The under estimation processing screen 700 illustrated in FIG. 7 is displayed on the liquid crystal display 321 during the execution of the estimation of the use environment by the utilization environment estimation unit 450 described above, separately from the environment type list screen 500. The under estimation processing screen 700 includes a message 701 and a message 702. The displayed message 701 contains character information “Environment Type is under Estimation” indicating that the estimation processing for the use environment is being executed. The displayed message 702 contains character information “Takes about One Minute to Estimate” indicating time taken to execute the estimation processing for the use environment. When the estimation processing is completed, the utilization environment estimation unit 450 notifies the security setting control unit 430 of the completion. Upon receipt of this notification, the security setting control unit 430 notifies the operation control unit 410 of the estimation completion. As a result, the display on the liquid crystal display 321 changes to an estimation result confirmation screen 800 illustrated in FIG. 8.

The estimation result confirmation screen 800 illustrated in FIG. 8 includes a message 801 and a button 802. The displayed message 801 contains, for example, “Recommended Environment Type: 4. Home Type” as an estimation result acquired by the utilization environment estimation unit 450. This enables users to operate the button 802 after confirming the message 801. This operation enables collectively performing security setting that reflects the recommended use environment.

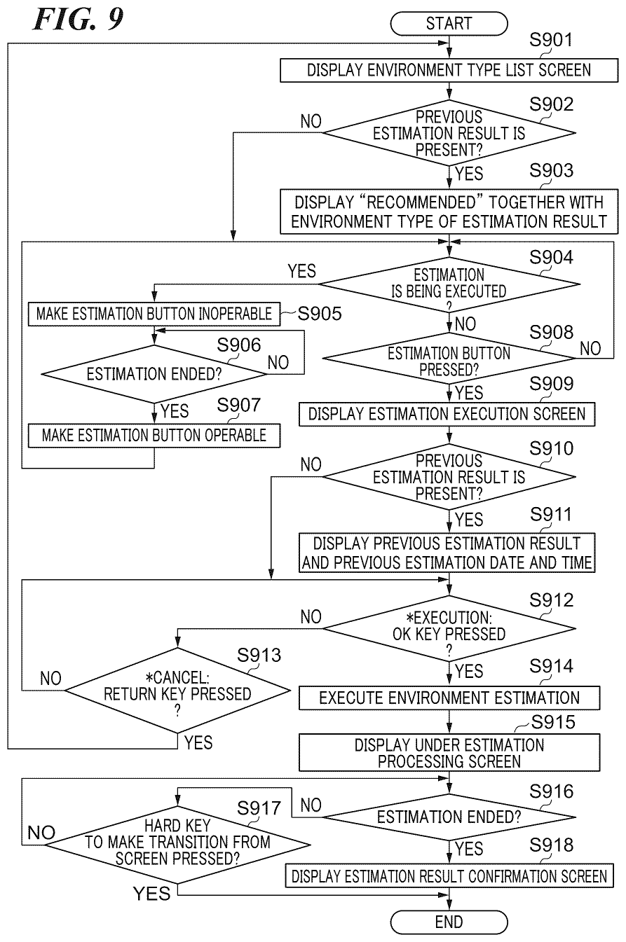

FIG. 9 is a flowchart illustrating processes executed by the image forming apparatus. A program, that when executed, implements the flowchart illustrated in FIG. 9, is stored in the ROM 312 or the HDD 314. The CPU 311 loads this program into the RAM 313 and then executes it. Execution of the program based on the flowchart illustrated in FIG. 9 starts when the environment type list screen 500 is displayed on the liquid crystal display 321.

As illustrated in FIG. 9, in step S901, the operation control unit 410 performs control to display the environment type list screen 500 on the liquid crystal display 321. After the execution of step S901, the processing proceeds to step S902.

In step S902, the security setting control unit 430 determines whether a previous estimation result acquired by the utilization environment estimation unit 450 is present. In a case where it is determined that the previous estimation result is present, the processing proceeds to step S903. In a case where it is determined that no previous estimation result is present, the processing proceeds to step S904.

In step S903, the security setting control unit 430 reads the previous estimation result from the utilization environment estimation unit 450. The operation control unit 410 causes the liquid crystal display 321 to indicate the word “Recommended” on one of the buttons 501a to 501f in the use environment list button group 501. For example, when the previous estimation result is “4. Home Type”, the operation control unit 410 controls to indicate, on the liquid crystal display 321, the word “Recommended” on the button 501d marked with “4. Home Type”. After execution of step S903, the processing proceeds to step S904.

In step S904, the security setting control unit 430 determines whether the utilization environment estimation unit 450 is executing estimation processing. In a case where it is determined that the estimation processing is being executed, the processing proceeds to step S905. In a case where it is determined that the estimation processing is not being executed, the processing proceeds to step S908.

In step S905, the security setting control unit 430 grays out the estimation button 502 on the liquid crystal display 321 to prevent operations on the estimation button 502. After the execution of step S905, the processing proceeds to step S906.

In step S906, the security setting control unit 430 determines whether the estimation processing by the utilization environment estimation unit 450 has ended. In a case where it is determined that the estimation processing has ended, the processing proceeds to step S907. When it is determined that the estimation processing has not yet ended, the processing remains in step S906.

In step S907, the security setting control unit 430 releases the estimation button 502 from the inoperable state in step S905 and makes the estimation button 502 operable. After the execution of step S907, the processing returns to step S904, and the subsequent steps are executed.

In step S908, the operation control unit 410 determines whether the estimation button 502 has been operated (selected). In a case where it is determined that the estimation button 502 has been operated, the processing proceeds to step S909. The operation control unit 410 changes the character information on the estimation button 502 displayed on the liquid crystal display 321 to the under estimation information “Environment Type Under Estimation” (see FIG. 5B). In a case where it is determined that the estimation button 502 has not been operated, the processing returns to step S904, and the subsequent steps are executed.

In step S909, the operation control unit 410 displays the estimation execution screen 600 on the liquid crystal display 321. After the execution of step S909, the processing proceeds to step S910.

In step S910, the security setting control unit 430 determines whether a previous estimation result acquired by the utilization environment estimation unit 450 is present. In a case where it is determined that the previous estimation result is present, the processing proceeds to step S911. In a case where it is determined that no previous estimation result is present, the processing proceeds to step S912.

In step S911, the operation control unit 410 performs control to display the previous estimation result 601a and the previous estimation date and time 601b in the previous estimation result portion 601 on the estimation execution screen 600. After the execution of step S911, the processing proceeds to step S912.

In step S912, the security setting control unit 430 determines whether the estimation execution confirmation portion 602 (marked with “Execution: OK Key”) on the estimation execution screen 600 has been operated. In a case where it is determined that the estimation execution confirmation portion 602 has been operated, the processing proceeds to step S914. In a case where it is determined that the estimation execution confirmation portion 602 has not been operated, the processing proceeds to step S913.

In step S913, the security setting control unit 430 determines whether the return button 603 (marked with “Cancel: Return Key”) on the estimation execution screen 600 has been operated. In a case where it is determined that the return button 603 has been operated, the processing returns to step S901, and the subsequent steps are executed. In a case where it is determined that the return button 603 has not been operated, the processing returns to step S912, and the subsequent steps are executed.

In step S914, the security setting control unit 430 instructs the utilization environment estimation unit 450 to execute the estimation processing for the use environment. As a result, estimation processing is executed by the utilization environment estimation unit 450. After the execution in step S914, the processing proceeds to step S915.

In step S915, the operation control unit 410 performs control to display the under estimation processing screen 700 on the liquid crystal display 321. After execution in step S915, the processing proceeds to step S916.

In step S916, the security setting control unit 430 determines whether the estimation processing by the utilization environment estimation unit 450 has ended. In a case where it is determined that the estimation processing has ended, the processing proceeds to step S918. In a case where it is determined that the estimation processing has not yet ended, the processing proceeds to step S917.

In step S917, the security setting control unit 430 determines, for example, whether a predetermined key (hardware key) of the keyboard has been operated in a state in which the under estimation processing screen 700 is displayed on the liquid crystal display 321 in step S915. This predetermined operation is an operation to change the display of the liquid crystal display 321 from the under estimation processing screen 700 to another screen. This is not seen to be limiting, and examples thereof include a home screen including instruction buttons (icons) for instructing various processes that can be executed by the image forming apparatus, such as printing (print), copying, faxing, and scanning. In a case where it is determined that the predetermined operation has been performed, the processing ends. In a case where it is determined that the predetermined operation has not been performed, the processing returns to step S916, and the subsequent steps are executed.

In step S918, the operation control unit 410 performs control to display the estimation result confirmation screen 800 on the liquid crystal display 321 to end the processing.

In the image forming apparatus, the display of the liquid crystal display 321 changes in the order of the environment type list screen 500, the estimation execution screen 600, the under estimation processing screen 700, and the estimation result confirmation screen 800, but the display mode is not seen to be limited. For example, the display of the liquid crystal display 321 may be controlled in the order of displaying the environment type list screen 500, not displaying the environment type list screen 500, displaying the estimation execution screen 600, not displaying the estimation execution screen 600, displaying the under estimation processing screen 700, not displaying the under estimation processing screen 700, and displaying the estimation result confirmation screen 800. Alternatively, the display of the liquid crystal display 321 may be controlled in the order of displaying the environment type list screen 500, displaying the estimation execution screen 600, displaying the under estimation processing screen 700, and displaying the estimation result confirmation screen 800, and these screens may be arranged side by side. The display of the liquid crystal display 321 may be controlled in the order of displaying the environment type list screen 500, displaying the estimation execution screen 600, displaying the under estimation processing screen 700, and displaying the estimation result confirmation screen 800, and these screens may be arranged to overlap each other.

### Second Embodiment

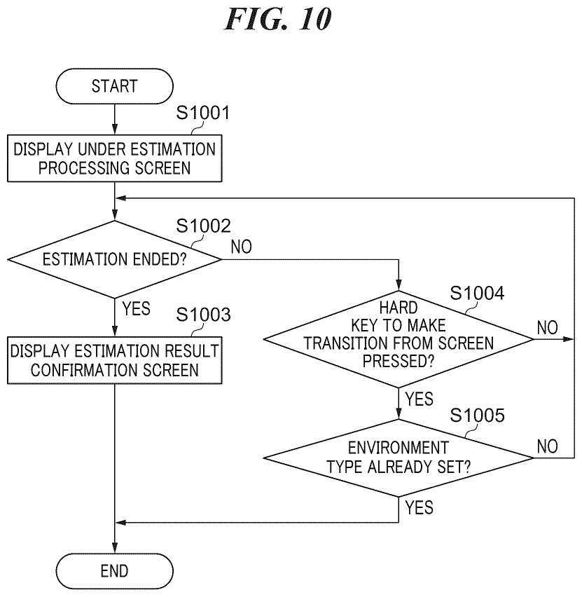

A second embodiment will now be described with reference to FIG. 10. The description focuses on the differences from the above-described embodiment, and the description of similar matters to the above-described embodiment will be omitted. FIG. 10 is a flowchart illustrating processes executed by an image forming apparatus according to a second embodiment. Execution of a program based on the flowchart illustrated in FIG. 10 starts when the under estimation processing screen 700 is displayed on the liquid crystal display 321.

As illustrated in FIG. 10, in step S1001, the operation control unit 410 performs control to display the under estimation processing screen 700 on the liquid crystal display 321. After the execution of step S1001, the processing proceeds to step S1002.

In step S1002, the security setting control unit 430 determines whether the estimation processing by the utilization environment estimation unit 450 has ended. In a case where it is determined that the estimation processing has ended, the processing proceeds to step S1003. In a case where it is determined that the estimation processing has not yet ended, the processing proceeds to step S1004.

In step S1003, the operation control unit 410 performs control to display the estimation result confirmation screen 800 on the liquid crystal display 321 to end the processing.

In step S1004, the security setting control unit 430 determines, for example, whether the predetermined key (hardware key) of the keyboard has been operated in a state in which the under estimation processing screen 700 is displayed on the liquid crystal display 321 in step S1001. In a case where it is determined that the predetermined key operation has been performed, the processing proceeds to step S1005. In a case where it is determined that the predetermined key operation has not been performed, the processing returns to step S1002, and the subsequent steps are executed.

In step S1005, the security setting control unit 430 determines whether the use environment (environment type) has already been set. This determination is made, for example, based on the current operation setting data 423. In a case where it is determined that the use environment has already been set, the processing ends. In a case where it is determined that the use environment has not already been set, the processing returns to step S1002, and the subsequent steps are executed.

In the present embodiment, in a case where the use environment has already been set, it can be presumed that provisional security by the security setting control unit 430 is ensured, and thus the display of the liquid crystal display 321 changes from the under estimation processing screen 700 to another screen. In a case where the use environment is not set, it can be presumed that the security is not ensured, and thus, it is preferable for users to confirm the estimation result on the estimation result confirmation screen 800. As a result, users may select the recommended use environment.

### Third Embodiment

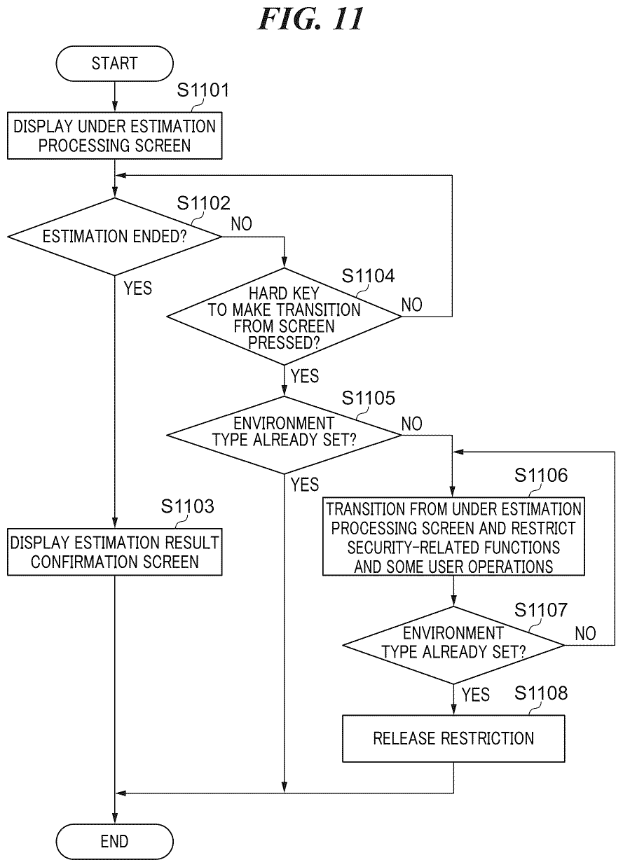

A third embodiment will now be described with reference to FIG. 11.

The description focuses on the differences from the above-described embodiments, and the description of similar matters to the above-described embodiments will be omitted. FIG. 11 is a flowchart illustrating processes executed by an image forming apparatus according to the third embodiment. Execution of a program based on the flowchart illustrated in FIG. 11 starts when the under estimation processing screen 700 is displayed on the liquid crystal display 321.

In the flowchart illustrated in FIG. 11, steps S1101 to S1105 are executed in order. Steps S1101 to S1105 are similar to steps S1001 to S1005 in the flowchart illustrated in FIG. 10.

As illustrated in FIG. 11, in a case where, in step S1105, it is determined that the use environment has already been set, the processing ends. In a case where, in step S1105, it is determined that the use environment has not already been set, the processing proceeds to step S1106.

In step S1106, the operation control unit 410 changes the display of the liquid crystal display 321 from the under estimation processing screen 700 displayed in step S1101 to another screen. The security setting control unit 430 restricts the security-related functions and some user operations. This restriction is not limited, and for example, user operations for printing, scan data transmission, and the like are restricted to take countermeasures against external data leakage. After the execution of step S1106, the processing proceeds to step S1107.

In step S1107, similarly to step S1105, the security setting control unit 430 determines whether the use environment (environment type) has already been set. In a case where it is determined that the use environment has already been set, the processing proceeds to step S1108. In a case where it is determined that the use environment has not already been set, the processing returns to step S1106, and the subsequent steps are executed.

In step S1108, the security setting control unit 430 releases the restriction by the security setting control unit 430 in step S1106, and the processing ends.

In the present embodiment, in a case where no use environment is set and there is a possibility that security is not ensured, the security-related functions and some user operations are restricted (see step S1106). This ensures provisional security.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-079259, filed May 15, 2024, which is hereby incorporated by reference wherein in its entirety.

What is claimed is:

1. An image processing apparatus comprising:
a display panel that displays a screen enabling a user to perform a scrolling operation; and
a controller that
performs control to display, on the display panel, an operation screen including an operation portion that receives an operation to instruct execution of estimation of a use environment in which the image processing apparatus is used and estimation execution information located together with the operation portion that indicates that the estimation is executed when the operation portion is operated, and
changes, while the estimation is being executed, the estimation execution information displayed on the display panel to under estimation information indicating that the estimation is being executed.

2. The image processing apparatus according to claim 1, wherein the operation portion and the estimation execution information are arranged in an upper portion of the operation screen.

3. The image processing apparatus according to claim 1, wherein the operation screen includes a plurality of options from which the use environment is selected and set, the plurality of options being arranged below the operation portion and the estimation execution information in the operation screen.

4. The image processing apparatus according to claim 1, wherein the under estimation information includes a character string indicating that the estimation is being executed.

5. The image processing apparatus according to claim 1, wherein in a case where an execution result of the estimation has been acquired, the controller performs control to display the execution result of the estimation on the display panel.

6. The image processing apparatus according to claim 1, wherein the controller performs control to display an under estimation screen indicating that the estimation is being executed on the display panel separately from the operation screen.

7. The image processing apparatus according to claim 6, wherein the under estimation screen includes a character string indicating that the estimation is being executed and time taken to execute the estimation.

8. The image processing apparatus according to claim 1, wherein the controller restricts an operation on the operation screen while the under estimation information is displayed on the display panel.

9. The image processing apparatus according to claim 1, wherein in a case where a predetermined operation is performed in a state where the under estimation information is displayed on the display panel, the controller performs control to display a screen different from the operation screen on the display panel.

10. A method for controlling an image processing apparatus including a display panel that displays a screen enabling a user to perform a scrolling operation, the method comprising:
displaying, on the display panel, an operation screen including an operation portion that receives an operation to instruct execution of estimation of a use environment in which the image processing apparatus is used and estimation execution information located together with the operation portion that indicates that the estimation is executed when the operation portion is operated; and
changing, while the estimation is being executed, the estimation execution information displayed on the display panel to under estimation information indicating that the estimation is being executed.

11. A non-transitory computer-readable storage medium storing instructions for causing an image processing apparatus including a display panel that displays a screen enabling a user to perform a scrolling operation to execute a method, the method comprising:
displaying, on the display panel, an operation screen including an operation portion that receives an operation to instruct execution of estimation of a use environment in which the image processing apparatus is used and estimation execution information located together with the operation portion that indicates that the estimation is executed when the operation portion is operated; and
changing, while the estimation is being executed, the estimation execution information displayed on the display panel to under estimation information indicating that the estimation is being executed.
